(19) United States
(12) Patent Application Publication
(10) Pub. No.: US 2007/0215666 A1
(43) Pub. Date: Sep. 20, 2007

(54) Gas Combustion Operated Fastener Driving Tool With Casing Floating At The Front End

(75) Inventors: Frederic Nayrac, Bourg Les Valence (FR); Bruno Toulouse, Tain L'Hermitage (FR); Ludovic Rousson, Saint Lager Bressac (FR); Patrick Herelier, Saint Jean De Muzols (FR)

Correspondence Address: LOWE, HAUPTMAN, GILMAN & BERNER, LLP (ITW), 1700 DIAGONAL ROAD, SUITE 300, ALEXANDRIA, VA, 22314, US

(73) Assignee: SOCIETE DE PROSPECTION ET D'INVENTIONS TECHNIQUES, Bourg-Les-Valence (FR)

(21) Appl. No.: 11/569,566

(22) PCT Filed: May 25, 2005
(86) PCT No.: PCT/IB05/01436

§ 371 Date: Nov. 22, 2006

(30) Foreign Application Priority Data
May 27, 2004 (FR) 04/05713

(51) Int. Cl. B25C 1/08

(52) U.S. Cl. 227/9

(57) ABSTRACT

The gas-operated fixing device comprises an internal combustion engine for driving fasteners, arranged in a case (9) fitted in a handle (13) and fixed to it at the rear (14-17, 56, 21-24). The front (91) of the case (9) is fitted floating in the handle (13) so as to be able to slide in it along the drive axis (20) of the fasteners. To be more specific, the case (9) and the handle of the device (11-13) are fixed to each other by tenon (49, 50) and slot (47, 48) assemblies.

The invention lies in the sphere of internal combustion engine gas-operated fixing devices. They operate on the principle of explosion of an inflammable mixture of gas and air in the combustion chamber of the engine, formed partly of a cylinder, a cylinder sleeve and a cylinder head, to propel into the cylinder a piston for driving a fixing device.

The engine is arranged in a casing.

The case is arranged in the two shells of a handle to which it is fixed both at the front and at the rear. To be more specific, at the rear, the cylinder head of the engine, the casing and the handle shells are fixed together with the same bolts.

When the inflammable mixture in the combustion chamber is under pressure, a force directed towards the rear is exerted on the cylinder head and therefore on the casing to which it is connected.

Inversely, when, under the explosion action, the piston is propelled towards the front, it stops against a damper which is connected to the cylinder. A force directed forwards is thus exerted on the cylinder and therefore on the casing to which it is connected.

In brief, the casing, generally made from plastic, is subjected to a high degree of pressure stresses, up to 60% of all these stresses.

The casing of the gas-operated fixing devices already acts as a flexible damper since it manages to stretch a little.

The applicant realized that the casing was deforming where it was easiest for it, i.e. at the front of the equipment.

Therefore, from a situation in which a gas-operated fixing device casing is integral with the handle of the device, both at the front and at the rear, the applicant conceived the idea of trying to solve the problem of separating the front of the casing from the handle so as to enable the casing to perform better its function as a damper.

So it is that the invention covered by this application is proposed.

The invention concerns a gas-operated fixing device comprising an internal combustion engine for driving fasteners, arranged in a casing fitted in a handle and fixed to it at the rear, characterized in that the front of the casing is fitted floating in the handle to be able to slide in it along the driving axis of the fasteners.

An extra major advantage of the invention is that it eliminates a large part of the relative vibrations of the casing and the handle, which aids the components housed in the handle of the device, particularly the electronic components. It also makes everything more comfortable for the operator.

In one interesting form of making the device covered by the invention, the front of the casing is fitted so as to slide in the handle towards the front up to front stops, and advantageously towards the rear up to rear stops.

In the preferred form of the device covered by the invention, the casing and the handle of the device are fixed to each other by tenon and slot assemblies.

The tenons and slots are advantageously oblong in shape, the tenons being shorter than the slots at the front of the casing.

The invention will be better understood by reading the following description, developed with reference to the appended drawing in which

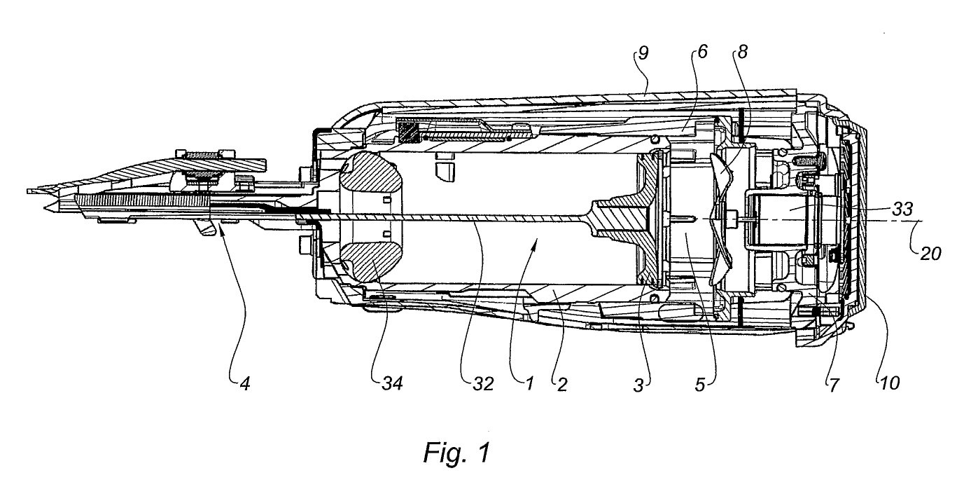

FIG. 1 is an axial section view of the fixing device of the invention;

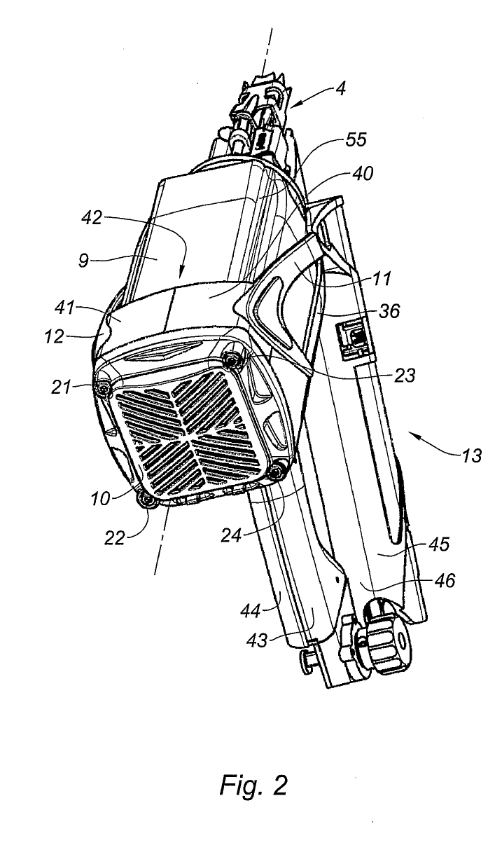

FIG. 2 is a rear perspective view of the device of the invention, and

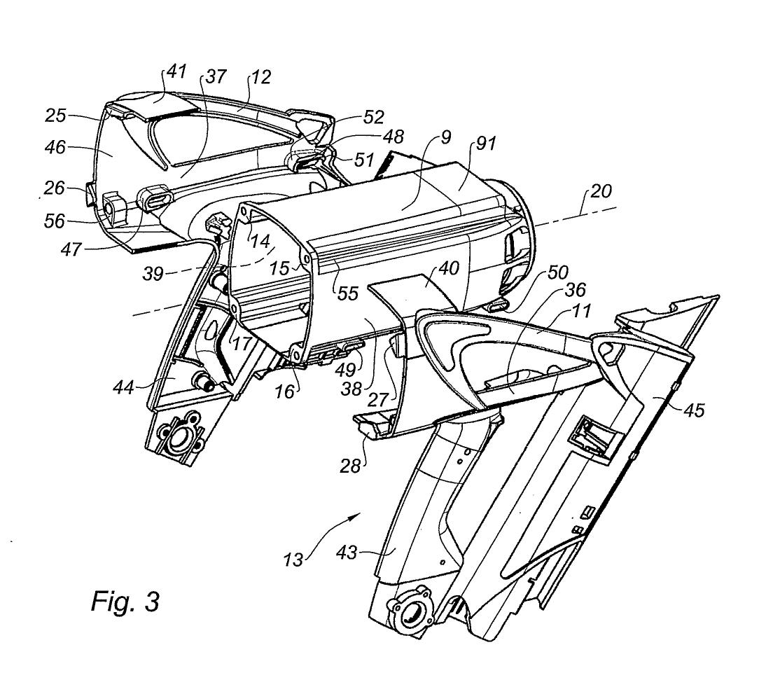

FIG. 3 is an exploded perspective view, slightly to the rear, of the casing and of the shells of the handle of the device.

The heat engine 1 of the device of the invention consists essentially, on the one hand, of a cylinder 2, with a centreline 20, in which a piston 3, with its rod 32, is fitted so as to slide in order to drive a fastener through a nose, or guide point, 4, of the device, and, on the other hand, a combustion chamber 5, formed at the rear of the cylinder 2, of a cylinder sleeve 6, the drive piston 3 and a cylinder head 7. A fan 8 for stirring the inflammable mixture, draining and cooling, is arranged in the chamber 5, its electric motor 33 being housed in the cylinder head 7, beyond which a spark plug (not shown) projects into the chamber. In its forward stroke the piston 3 abuts against a shock absorber 34 arranged at the front end of the cylinder.

The heat engine is arranged in a casing 9 closed at the rear by a ventilation cover 10 and two shells 11, 12 of a handle 13. To be more precise, the casing has four angle grooves such as groove 55 in FIGS. 2 and 3, ending at the rear with four supporting shoulders 14, 17, in each of which a smooth bore is drilled to take, driven through the bores, four bolts 21-24 for fixing the cover 10 and the handle shells 11, 12, the bolts being screwed into two pairs of tapped angle stiffeners such as the stiffener 56 in FIG. 3, formed at the rear of the shells, on their inside wall, these stiffeners being housed in the grooves 55 of the casing, supported against the shoulders 14-17. The angle stiffeners 25-28 at the rear of the shells can retain the cylinder head 7 in certain instances.

Each of the handle shells has a pierced frame 36 (37) designed to be laid against a side wall 38 (39) of the casing and, at the rear, a semi-flange 40 (41) to improve the rear covering of the casing by the two semi-flanges joined, by tongue and groove, as a fixing sleeve 42. Each shell is extended at the rear by the real handle part 43 (44) and, at the front, by a housing or supporting structure 45 (46), either for an electricity supply battery or for a fasteners charger.

Therefore, the engine 1 is arranged in the casing 9 which is fitted into the assembly of the two shells 11, 12 of the handle 13 to which it is fixed at the rear by the bolts 21-24.

On their inner surface 46, at the bottom near the handle 43, 44, the shell cheeks 36, 37 carry, from the same castings, small annular funnels, oblong in section, one 47 at the rear and another 48 at the front. FIG. 3 shows only the inside surface and the funnels of the left side cheek 37. As will already have been noted, the fixing arrangement has a plane of symmetry going through the centreline 20.

The side walls 38, 39 of the casing 9, in positions corresponding to those of the funnels 47, 48, therefore at the bottom at the front and at the rear, also have, from the same casting, small annular funnels 49, 50, also oblong in section, designed to work in conjunction by fitting into each other, like tenons and slots, with the funnels 47, 48 of the shell cheeks 36, 37. FIG. 3 shows only the funnels 49, 50 of the side wall 38 of the case 9. The rear tenons and slots 49, 47, more of less with the same inside and outside sections, fit overall more or less by force fitting into each other. On the other hand, the front tenons and slots 50, 48, fit into each other with a slight force fit in their cross dimension but not in their dimension parallel to the centreline 20. In other words, the outside axial length of the tenons 50 of the front part 91 of the case 9 is appreciably shorter than the inside axial length of the slots 48, specifically to enable axial sliding of the tenons in the slots. Thus, the front 91 of the case 9 is fitted floating in the handle 11-13 and can slide in it along the drive axis 20 of the fasteners.

Of course, the respective arrangements of the tenons and slots could be reversed, the tenons forming part of the casting of the handle shells. In all cases, the front tenons are shorter than the front slots.

The front 51 and rear 52 annular walls of the front funnel slots 48 act as front and rear stop parts for the front tenons 50 of the case.

1-5. (canceled)

6. Gas-operated fixing device comprising an internal combustion engine for driving fasteners arranged in a casing fitted in a handle and fixed to it at the rear, characterized in that the front of the case is fitted floating in the handle so as to be able to slide in it along the drive axis of the fasteners.

7. Fixing device according to claim 6, whereby the front of the case is fitted for sliding in the handle forward up to front means of stopping.

8. Fixing device according to claim 6, whereby the front of the case is fitted for sliding in the handle rearward up to rear means of stopping.

9. Fixing device according to claims 6, whereby the case and the handle of the device are fixed to each other by tenon and slot assemblies.

10. Fixing device according to claim 9, whereby the tenons and the slots are oblong in shape, the tenons being shorter than the slots at the front of the case.
